(19) United States
(12) Patent Application Publication
(10) Pub. No.: US 2024/0405578 A1
(43) Pub. Date: Dec. 5, 2024

(54) POWER SUPPLY DEVICE, CONTROL DEVICE, AND CONTROL METHOD

(71) Applicant: HONDA MOTOR CO., LTD., Tokyo (JP)

(72) Inventors: Kenji Shibata, Wako-shi, Saitama (JP); Tatsuya Jinno, Wako-shi, Saitama (JP)

(73) Assignee: HONDA MOTOR CO., LTD., Tokyo (JP)

(21) Appl. No.: 18/696,118

(22) PCT Filed: Sep. 29, 2021
(86) PCT No.: PCT/JP2021/035989

§ 371 Date: Mar. 27, 2024

(51) Int. Cl. H02J 7/00; H02J 7/34

(52) U.S. Cl. CPC H02J 7/0024; H02J 7/0063; H02J 7/007182; H02J 7/342

(57) ABSTRACT

A power supply device for outputting a constant voltage to a load, including a power supply unit that has a first battery unit including at least one battery and a second battery unit including at least one battery, a switching unit configured to switch connection between the first battery unit and the second battery unit to series connection or parallel connection, and a control unit configured to control the switching unit so that a voltage set value set in advance according to a specification required by the load is supplied to the load, wherein the control unit controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and controls the switching unit so that the connection between the first battery unit and the second battery unit is the series connection, when the first voltage value and the second voltage value are not equal to or larger than the switching voltage value is provided.

### TECHNICAL FIELD

The present invention relates to a power supply device, a control device, and a control method.

### BACKGROUND ART

In recent years, with increasing interest in environmental problems such as global warming, a power supply device that supplies electric power stored in a battery (a secondary battery or a storage battery) instead of a power supply device that generates electric power by driving a generator by an internal combustion engine has attracted attention as a portable power supply device useful in a region where a transmission network is not widespread or at the time of a power failure of a commercial power supply. As an example of such a power supply device, there has been proposed a power supply device in which a plurality of batteries are mounted and a connected state of the batteries can be switched to series connection or parallel connection (see PTLs 1 and 2).

### CITATION LIST

### Patent Literature

PTL 1: Japanese Patent Laid-Open No. 2013-192278
PTL 2: Japanese Patent Laid-Open No. 2012-60838

### SUMMARY OF INVENTION

### Technical Problem

In a power supply device in which a battery is mounted, in particular, as one of functions required in a portable power supply device, there is a function of constantly maintaining a voltage output from the power supply device, so-called constant voltage output. Therefore, also in a power supply device in which a plurality of batteries are mounted, there is a demand for technology for realizing constant power output while switching a connected state of these batteries to series connection or parallel connection. Note that technologies disclosed in PTLs 1 and 2 are power supply devices mounted on a vehicle (that is, since a portable power supply device is not assumed,), and are useful technologies for load fluctuation and heat generation, but do not realize constant power output.

An exemplary object of the present invention is to provide new technology related to a power supply device in which a plurality of batteries are mounted.

### Solution to Problem

A power supply device as one aspect of the present invention is a power supply device for outputting a constant voltage to a load, characterized by comprising a power supply unit that has a first battery unit including at least one battery and a second battery unit including at least one battery, a switching unit that switches connection between the first battery unit and the second battery unit to series connection or parallel connection, and a control unit, wherein the control unit controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and controls the switching unit so that the connection between the first battery unit and the second battery unit is the series connection, when the first voltage value and the second voltage value are not equal to or larger than the switching voltage value.

A control device as another aspect of the present invention is a control device for controlling a power supply device including a power supply unit having a first battery unit including at least one battery and a second battery unit including at least one battery, the power supply device outputting a constant voltage to a load, the control device characterized by comprising a switching unit that switches connection between the first battery unit and the second battery unit to series connection or parallel connection, and a control unit, wherein the control unit controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and controls the switching unit so that the connection between the first battery unit and the second battery unit is the series connection, when the first voltage value and the second voltage value are not equal to or larger than the switching voltage value.

A control method as yet another aspect of the present invention is a control method for controlling a power supply device including a power supply unit having a first battery unit including at least one battery and a second battery unit including at least one battery, the power supply device outputting a constant voltage to a load, the method characterized by comprising a step of switching connection between the first battery unit and the second battery unit to series connection or parallel connection, the step including switching the connection between the first battery unit and the second battery unit to the parallel connection when a first voltage value that is a value of a voltage output from the first battery unit and a second voltage value that is a value of a voltage output from the second battery unit are equal to or larger than a predetermined switching voltage value, and switching the connection between the first battery unit and the second battery unit to the series connection when the first voltage value and the second voltage value are not equal to or larger than the switching voltage value.

### Advantageous Effects of Invention

According to the present invention, for example, it is possible to provide new technology related to a power supply device in which a plurality of batteries are mounted.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a schematic diagram illustrating a configuration of a power supply device as one aspect of the present invention.

FIG. 2 is a schematic diagram illustrating a configuration of a power supply device in the conventional technology.

FIG. 3 is a schematic diagram illustrating a configuration of a power supply device in the present embodiment.

FIG. 4 is a schematic diagram illustrating a configuration of the power supply device in the present embodiment.

FIG. 5 is a schematic diagram illustrating a configuration of a power supply device in the conventional technology.

FIG. 6 is a schematic diagram illustrating a configuration of the power supply device in the present embodiment.

FIG. 7 is a schematic diagram illustrating a configuration of the power supply device in the present embodiment.

FIG. 8 is a flowchart illustrating the operation of the power supply device illustrated in FIG. 1.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

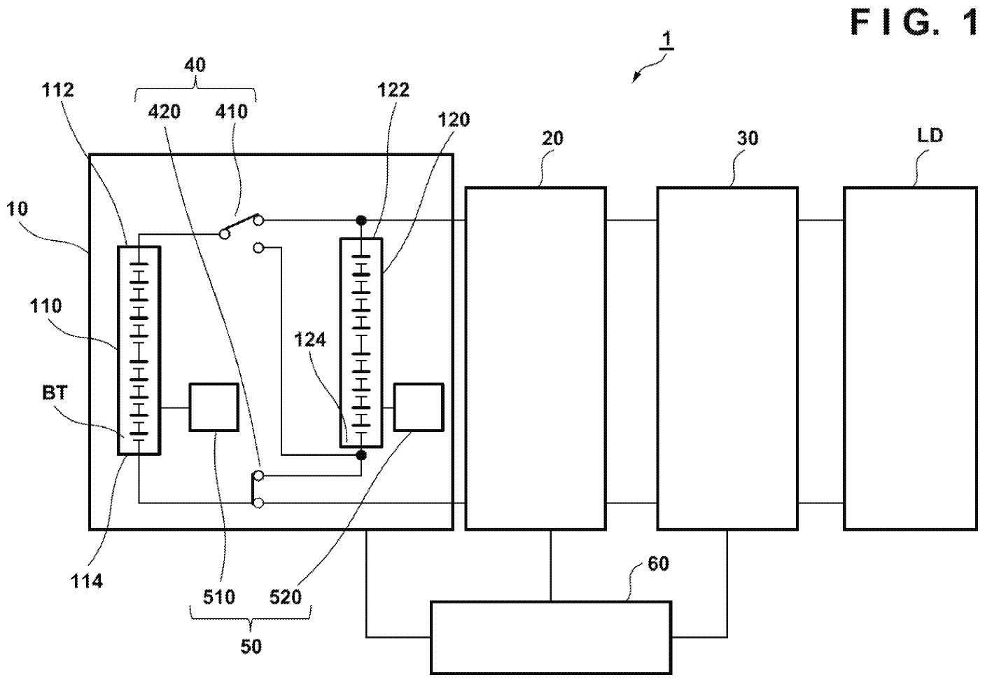

FIG. 1 is a schematic diagram illustrating a configuration of a power supply device 1 as one aspect of the present invention. The power supply device 1 supplies electric power to a load LD such as an electric device connected to the power supply device 1 without requiring a commercial power supply. In the present embodiment, the power supply device 1 is embodied as a constant voltage power supply having a function of constantly maintaining a voltage output from the power supply device 1 to the load LD constant (realizing constant voltage output). The power supply device 1 is suitable as, for example, a portable power supply device used in a region where a transmission network is not widespread or at the time of a power failure of a commercial power supply.

As illustrated in FIG. 1, the power supply device 1 has a power supply unit 10, a DC/DC converter 20, a DC/AC inverter 30, a switching unit 40, a detection unit 50, and a control unit 60.

The power supply unit 10 is configured as a battery pack in which a plurality of batteries BT are mounted. In the present embodiment, the power supply unit 10 has a first battery unit 110 including a plurality of batteries BT and a second battery unit 120 including a plurality of batteries BT. In FIG. 1, each of the first battery unit 110 and the second battery unit 120 includes 10 batteries BT, but the number of batteries is not limited and at least one battery BT may be included. In addition, the number of batteries BT included in the first battery unit 110 and the number of batteries BT included in the second battery unit 120 may not be the same. The battery BT is a storage battery (secondary battery) for supplying electric power to the load LD.

The first battery unit 110 is provided with terminals for outputting electric power from the plurality of batteries BT included in the first battery unit 110, specifically, a terminal 112 on the positive electrode side (first electrode side) and a terminal 114 on the negative electrode side (second electrode side). Similarly, the second battery unit 120 is provided with terminals for outputting electric power from the plurality of batteries BT included in the second battery unit 120, specifically, a terminal 122 on the positive electrode side (first electrode side) and a terminal 124 on the negative electrode side (second electrode side).

The DC/DC converter 20 is provided between the power supply unit 10 and the load LD, in the present embodiment, between the power supply unit 10 and the DC/AC inverter 40. The DC/DC converter 20 is a boosting converter that uses electromagnetic induction generated in a coil to boost a DC voltage (voltage value) output from the power supply unit 10 to a voltage set value set in advance according to a specification required by the load LD. The DC/DC converter 20 includes, for example, an internal power supply, a CPU, and a converter unit having a circuit configuration including a coil, a MOSFET (switch element), a diode, and a capacitor.

The DC/AC inverter 30 is provided between the DC/DC converter 20 and the load LD. The DC/AC inverter 30 converts a DC voltage input from the DC/DC converter 20 and boosted by the DC/DC converter 20 into an AC voltage, and outputs (supplies) the AC voltage to the load LD. The DC/AC inverter 30 suppresses variations in output by performing pulse width modulation (PWM) control or the like, for example, when converting the DC voltage into the AC voltage. The DC/AC inverter 30 includes, for example, an internal power supply, a CPU, a driver, an H-bridge circuit (four switch circuits) including transistors, and a filter (an LC filter, a noise filter, or the like).

The switching unit 40 has a function of switching connection between the first battery unit 110 and the second battery unit 120 to series connection or parallel connection in the power supply unit 10. In the present embodiment, the switching unit 40 includes a first relay 410 and a second relay 420. The first relay 410 is provided between the first battery unit 110 and the second battery unit 120, and is a component (switch) for switching the connection destination of the terminal 112 on the positive electrode side of the first battery unit 110 to the terminal 122 on the positive electrode side of the second battery unit 120 or the terminal 124 on the negative electrode side of the second battery unit 120. The second relay 420 is provided between the first battery unit 110 and the second battery unit 120, and is a component (switch) for switching a state between the terminal 114 on the negative electrode side of the first battery unit 110 and the terminal 124 on the negative electrode side of the second battery unit 120 to a connected state or a non-connected state. Note that the configuration of the switching unit 40 is not limited. However, as illustrated in FIG. 1, by configuring the switching unit 40 with the first relay 410 and the second relay 420, a function of switching the connection between the first battery unit 110 and the second battery unit 120 to the series connection or the parallel connection can be realized with a simple configuration.

The detection unit 50 has a function of detecting a value (hereinafter, referred to as a “first voltage value”) of the voltage output from the first battery unit 110 and a value (hereinafter, referred to as a “second voltage value”) of the voltage output from the second battery unit 120. In the present embodiment, the detection unit 50 includes a first voltage detection unit 510 provided for the first battery unit 110 and a second voltage detection unit 520 provided for the second battery unit 120. The first voltage detection unit 510 includes, for example, a movable coil type DC voltmeter including a permanent magnet and a coil, and detects the first voltage value by detecting the value of the voltage output from each battery BT included in the first battery unit 110. Similarly, the second voltage detection unit 520 includes, for example, a movable coil type DC voltmeter including a permanent magnet and a coil, and detects the second voltage value by detecting the value of the voltage output from each battery BT included in the second battery unit 120.

The control unit 60 is a control device including a processor represented by a CPU, a storage device such as a semiconductor memory, an interface, and the like. For example, the control unit 60 integrally controls each unit of the power supply device 1 according to a program stored in a storage unit to operate the power supply device 1. In the present embodiment, the control unit 60 is configured separately from each unit of the power supply device 1, but is not limited thereto, and may be configured integrally with the DC/DC converter 20, for example.

In operating the power supply device 1, in the present embodiment, the control unit 60 controls the switching unit 40 based on the first voltage value and the second voltage value detected by the detection unit 50. When the first voltage value and the second voltage value are detected in advance using, for example, an external device or the like, the switching unit 40 may be controlled based on the first voltage value and the second voltage value acquired from the external device. In other words, the first voltage value and the second voltage value are not necessarily detected by the detection unit 50. In this case, it is not necessary to provide the detection unit 50 in the power supply device 1, which contributes to a reduction in the overall size and cost of the power supply device 1. However, by providing the detection unit 50 as in the present embodiment, the value (first voltage value) of the voltage output from the first battery unit 110 and the value (second voltage value) of the voltage output from the second battery unit 120 can be always detected during the operation of the power supply device 1, so that the switching unit 40 described later can be controlled with high accuracy.

For example, when the first voltage value that is the value of the voltage output from the first battery unit 110 and the second voltage value that is the value of the voltage output from the second battery unit 120 are equal to or larger than a predetermined switching voltage value, the control unit 60 controls the switching unit 40 so that the connection between the first battery unit 110 and the second battery unit 120 is the parallel connection. Specifically, in order to cause the connection between the first battery unit 110 and the second battery unit 120 to be the parallel connection, the control unit 60 controls the first relay 410 so that the terminal 112 on the positive electrode side of the first battery unit 110 and the terminal 122 on the positive electrode side of the second battery unit 120 are connected, and controls the second relay 420 so that the state between the terminal 114 on the negative electrode side of the first battery unit 110 and the terminal 124 on the negative electrode side of the second battery unit 120 is the connected state.

On the other hand, when the first voltage value that is the value of the voltage output from the first battery unit 110 and the second voltage value that is the value of the voltage output from the second battery unit 120 are not equal to or larger than the predetermined switching voltage value, the control unit 60 controls the switching unit 40 so that the connection between the first battery unit 110 and the second battery unit 120 is the series connection. Specifically, in order to cause the connection between the first battery unit 110 and the second battery unit 120 to be the series connection, the control unit 60 controls the first relay 410 so that the terminal 112 on the positive electrode side of the first battery unit 110 and the terminal 124 on the negative electrode side of the second battery unit 120 are connected, and controls the second relay 420 so that the state between the terminal 114 on the negative electrode side of the first battery unit 110 and the terminal 124 on the negative electrode side of the second battery unit 120 is the non-connected state.

Hereinafter, an advantage (effect) obtained in the present embodiment in which the connection between the first battery unit 110 and the second battery unit 120 can be switched between the series connection and the parallel connection will be described while comparing the present embodiment with the conventional technology in which the connection between the first battery unit and the second battery unit is fixed to the parallel connection.

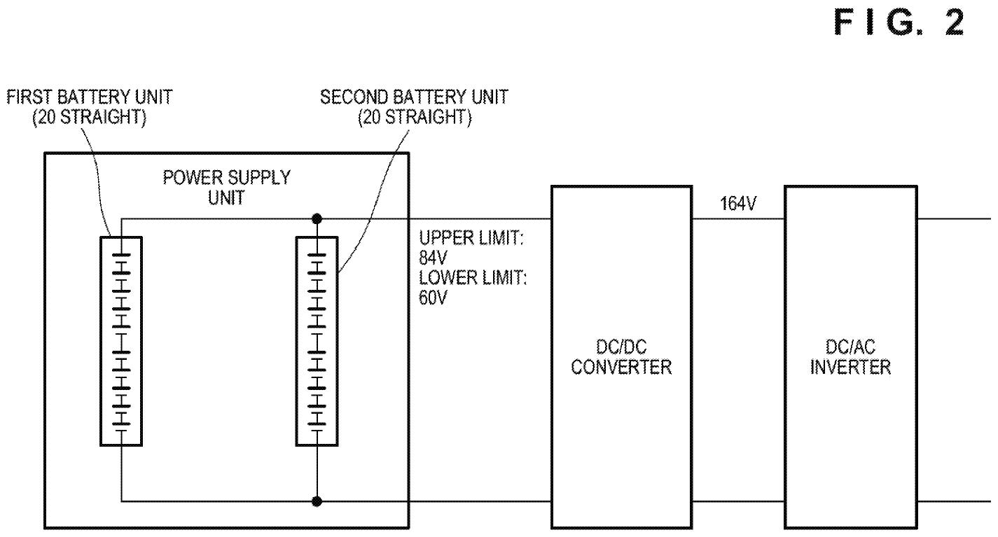

FIG. 2 is a schematic diagram illustrating a configuration of a power supply device in the conventional technology, and illustrates a connected state of a first battery unit, a second battery unit, a DC/DC converter, and a DC/AC inverter. As illustrated in FIG. 2, in the conventional technology, the first battery unit and the second battery unit are connected to the DC/DC converter and the DC/AC inverter at the subsequent stages in a state where the connection between the first battery unit and the second battery unit is fixed to the parallel connection. Here, it is assumed that use conditions of each battery (single battery) included in each of the first battery unit and the second battery unit are, for example, an upper limit (voltage upper limit): 4.2 V and a lower limit (voltage lower limit): 3.0 V. It is assumed that each of the first battery unit and the second battery unit has a configuration in which 20 batteries are disposed in series (so-called 20 straight). In addition, it is assumed that the DC/DC converter boosts a voltage output from the power supply unit including the first battery unit and the second battery unit to, for example, 164 V set in advance as a voltage set value. In the conventional technology, since the connection between the first battery unit and the second battery unit is fixed to the parallel connection, the voltage (voltage value) output from the power supply unit has an upper limit: 4.2×20=84 V and a lower limit: 3.0×20=60 V. Therefore, in the conventional technology, in the DC/DC converter, it is necessary to boost 60 V (lower limit of the voltage output from the power supply unit) to 164 V (voltage set value). In other words, in the conventional technology, the DC/DC converter should be configured to be able to boost the input voltage by at least 104 V (=164 V-60 V).

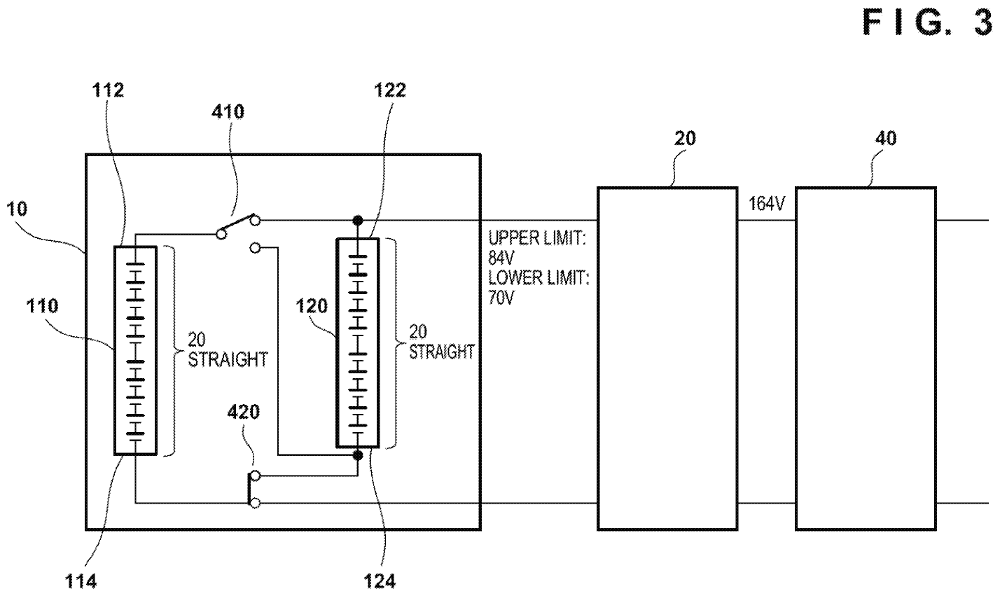

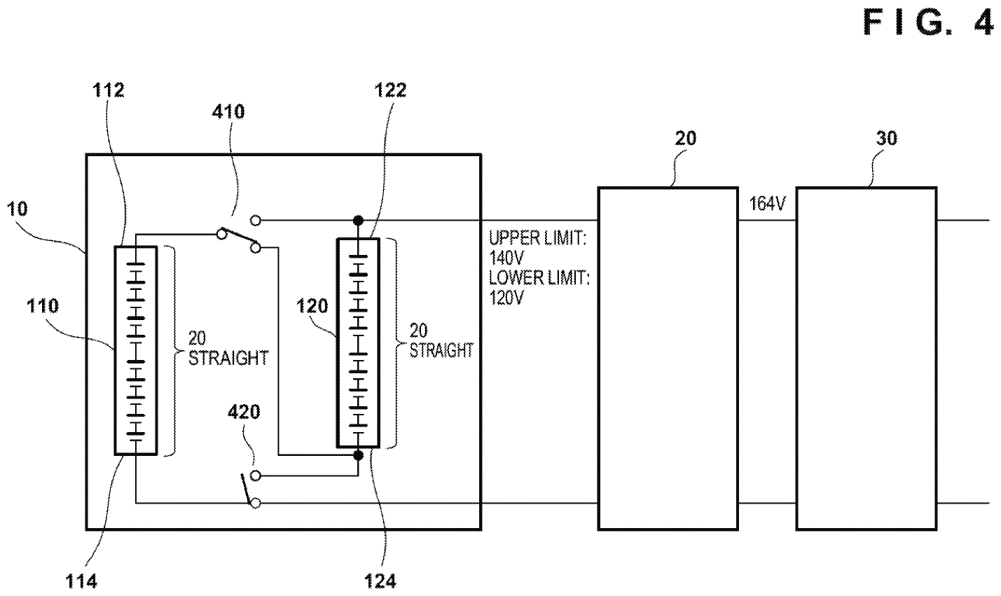

FIGS. 3 and 4 are schematic diagrams illustrating the configuration of the power supply device 1 in the present embodiment. FIG. 3 illustrates a state in which the connection between the first battery unit 110 and the second battery unit 120 is the parallel connection, and FIG. 4 illustrates a state in which the connection between the first battery unit 110 and the second battery unit 120 is the series connection. Referring to FIGS. 3 and 4, in the present embodiment, as described above, the first battery unit 110 and the second battery unit 120 are connected to the DC/DC converter 20 and the DC/AC inverter 30 at the subsequent stages in a state where the connection between the first battery unit 110 and the second battery unit 120 is switchable between the series connection and the parallel connection. Here, similarly to the conventional technology, it is assumed that use conditions of each battery BT included in each of the first battery unit 110 and the second battery unit 120 are an upper limit: 4.2 V and a lower limit: 3.0 V. It is assumed that each of the first battery unit 110 and the second battery unit 120 has a configuration in which 20 batteries BT are disposed in series (so-called 20 straight). In addition, it is assumed that the DC/DC converter 20 boosts the voltage output from the power supply unit 10 including the first battery unit 110 and the second battery unit 120 to 164 V set in advance as a voltage set value. Note that a switching voltage value for switching the connection between the first battery unit 110 and the second battery unit 120 between the series connection and the parallel connection, specifically, for switching the connection from the parallel connection to the series connection is set to 3.5 V, which is a voltage value between the voltage upper limit and the voltage lower limit to be the use conditions of each battery BT.

In the present embodiment, when there is a margin in the voltage value output from each battery BT included in each of the first battery unit 110 and the second battery unit 120, that is, when the first voltage value and the second voltage value are equal to or larger than the switching voltage value, the connection between the first battery unit 110 and the second battery unit 120 is the parallel connection as illustrated in FIG. 3. Therefore, the voltage (voltage value) output from the power supply unit 10 has an upper limit: 4.2×20=84 V and a lower limit (switching voltage value): 3.5×20=70 V. Therefore, in the present embodiment, when the connection between the first battery unit 110 and the second battery unit 120 is the parallel connection, in the DC/DC converter 20, it is necessary to boost 70 V (lower limit of the voltage output from the power supply unit 10) to 164 V (voltage set value).

In the present embodiment, when there is no margin in the voltage value output from each battery BT included in each of the first battery unit 110 and the second battery unit 120, that is, when the first voltage value and the second voltage value are not equal to or larger than the switching voltage value, the connection between the first battery unit 110 and the second battery unit 120 is the series connection as illustrated in FIG. 4. Therefore, the voltage (voltage value) output from the power supply unit 10 has an upper limit (switching voltage value): 3.5×20×2=140 V and a lower limit: 3.0×20×2=120 V. Therefore, in the present embodiment, when the connection between the first battery unit 110 and the second battery unit 120 is the series connection, in the DC/DC converter 20, it is necessary to boost 120 V (lower limit of the voltage output from the power supply unit 10) to 164 V (voltage set value).

As described above, in the present embodiment, the lower limit of the voltage output from the power supply unit 10 is 70 V, which is the lower limit of the voltage output from the power supply unit 10 when the connection between the first battery unit 110 and the second battery unit 120 is the parallel connection. Therefore, the DC/DC converter 20 may be configured to be able to boost the input voltage by at least 94 V (=164 V−70 V). Therefore, in the present embodiment, a boosting ratio required for the DC/DC converter 20 can be reduced as compared with the conventional technology in which boosting of 104 V is required in the DC/DC converter. As a result, it is possible to reduce the size and cost of the DC/DC converter 20 and to reduce the overall size and cost of the power supply device 1. In addition, in the present embodiment, setting of a withstand voltage can be lowered as compared with the case where the connection between the first battery unit 110 and the second battery unit 120 is fixed to the series connection.

Note that, in FIG. 1, the power supply device 1 includes the DC/DC converter 20 as a component, but is not limited thereto, and may not include the DC/DC converter 20. In this case, the DC/AC inverter 30 is provided between the power supply unit 10 and the load LD, and converts a DC voltage output from the power supply unit 10 into an AC voltage.

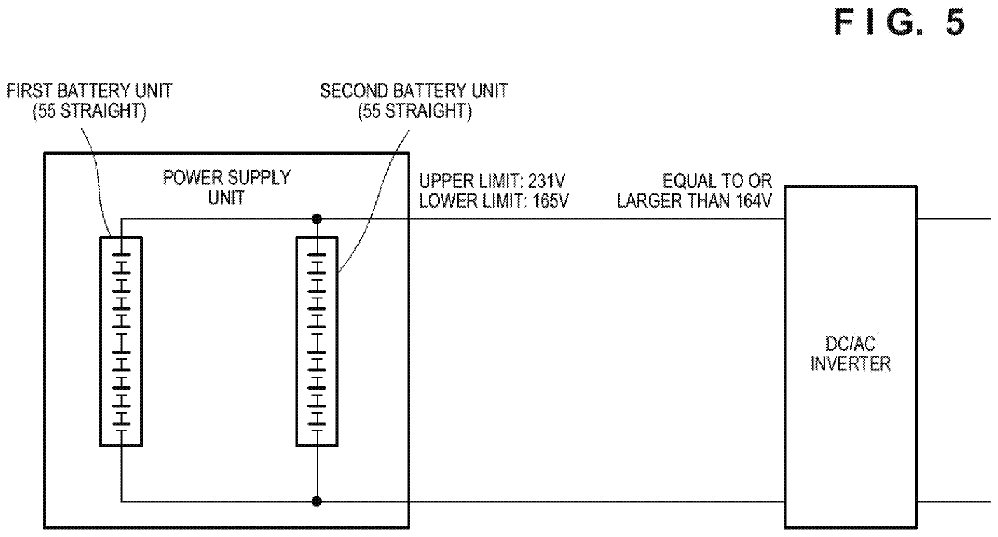

Hereinafter, with reference to FIGS. 5, 6, and 7, an advantage (effect) obtained in the present embodiment in which the connection between the first battery unit 110 and the second battery unit 120 can be switched between the series connection and the parallel connection will be described while comparing the present embodiment with the conventional technology in which the connection between the first battery unit and the second battery unit is fixed to the parallel connection, in a case where the power supply device 1 does not include the DC/DC converter 20.

FIG. 5 is a schematic diagram illustrating a configuration of the power supply device in the conventional technology, and illustrates a connected state of the first battery unit, the second battery unit, and the DC/AC inverter. As illustrated in FIG. 5, in the conventional technology, the first battery unit and the second battery unit are connected to the DC/AC inverter at the subsequent stage in a state where the connection between the first battery unit and the second battery unit is fixed to the parallel connection. Here, it is assumed that use conditions of each battery (single battery) included in each of the first battery unit and the second battery unit are, for example, an upper limit (voltage upper limit): 4.2 V and a lower limit (voltage lower limit): 3.0 V. When the power supply device does not include the DC/DC converter, the voltage (voltage lower limit) output from the power supply unit including the first battery unit and the second battery unit should be equal to or larger than 164 V, which is a voltage set value set in advance according to a specification required by the load LD. Therefore, in the conventional technology in which the connection between the first battery unit and the second battery unit is fixed to the parallel connection, each of the first battery unit and the second battery unit needs to have a configuration in which 55 batteries are disposed in series (so-called 55 straight). Note that the voltage (voltage value) output from the power supply unit has an upper limit: 4.2×55=231 V and a lower limit: 3.0×55=165 V.

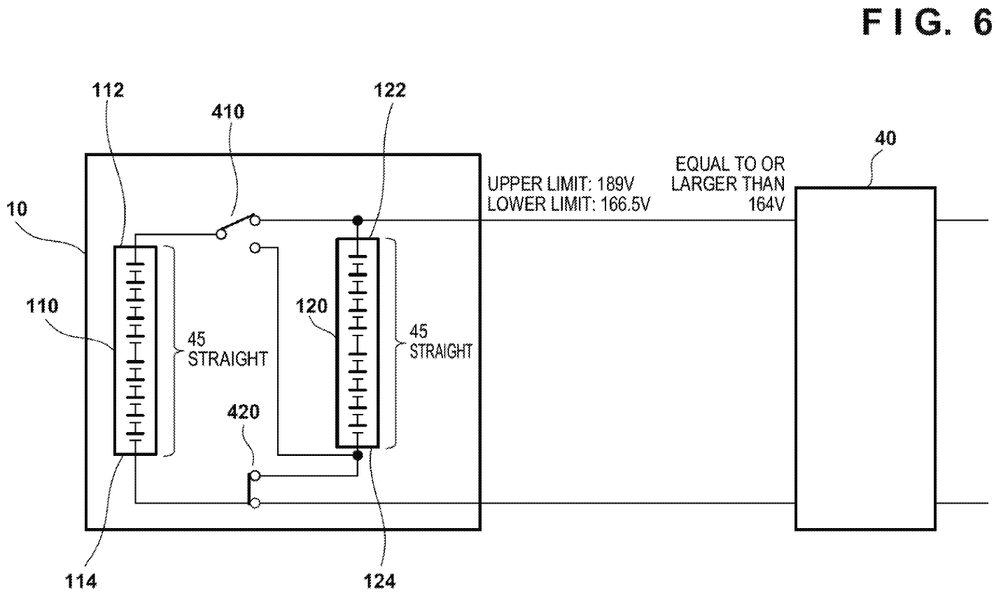

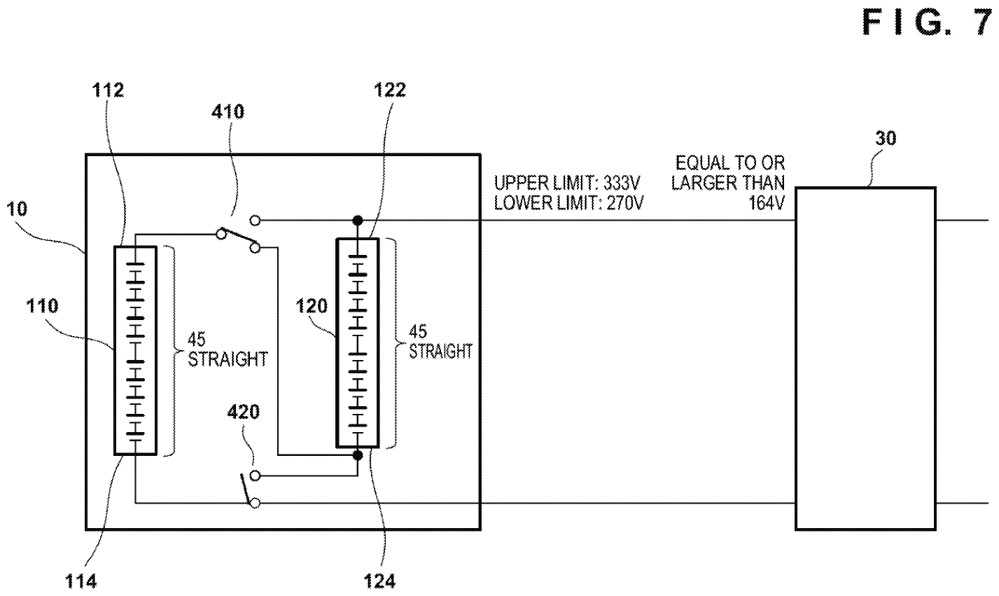

In the present embodiment, when there is a margin in the voltage value output from each battery BT included in each of the first battery unit 110 and the second battery unit 120, that is, when the first voltage value and the second voltage value are equal to or larger than the switching voltage value, the connection between the first battery unit 110 and the second battery unit 120 is the parallel connection as illustrated in FIG. 6. Further, in the present embodiment, when there is no margin in the voltage value output from each battery BT included in each of the first battery unit 110 and the second battery unit 120, that is, when the first voltage value and the second voltage value are not equal to or larger than the switching voltage value, the connection between the first battery unit 110 and the second battery unit 120 is the series connection as illustrated in FIG. 7.

As described above, the connection between the first battery unit 110 and the second battery unit 120 can be switched between the series connection and the parallel connection. Therefore, in a case where the power supply device 1 does not include the DC/DC converter 20, the number of batteries BT to be included in each of the first battery unit 110 and the second battery unit 120 can be reduced. For example, similarly to the conventional technology, it is assumed that use conditions of each battery BT included in each of the first battery unit 110 and the second battery unit 120 are an upper limit: 4.2 V and a lower limit: 3.0 V. In addition, it is assumed that the switching voltage value for switching the connection between the first battery unit 110 and the second battery unit 120 between the series connection and the parallel connection, specifically, for switching the connection from the parallel connection to the series connection is set to 3.7 V, which is a voltage value between the voltage upper limit and the voltage lower limit to be the use conditions of each battery BT. In this case, in order to cause the lower limit of the voltage output from the power supply unit 10 to be equal to or larger than 164 V when the connection between the first battery unit 110 and the second battery unit 120 is the parallel connection, each of the first battery unit 110 and the second battery unit 120 only needs to have a configuration in which at least 45 batteries are disposed in series (so-called 45 straight). As a result, when the connection between the first battery unit 110 and the second battery unit 120 is the parallel connection, the voltage (voltage value) output from the power supply unit 10 has an upper limit: 4.2×45=189 V and a lower limit (switching voltage value): 3.7×45=166.5 V. When the connection between the first battery unit 110 and the second battery unit 120 is the series connection, the voltage (voltage value) output from the power supply unit 10 has an upper limit (switching voltage value): 3.7×45×2=333 V and a lower limit: 3.0×45×2=270 V. Therefore, in the present embodiment, the number of batteries BT to be included in each of the first battery unit 110 and the second battery unit 120 can be reduced as compared with the conventional technology in which a configuration of 55 straight is required for each of the first battery unit and the second battery unit. This leads to reduction in size and cost of the power supply unit 10, and also contributes to reduction in overall size and cost of the power supply device 1.

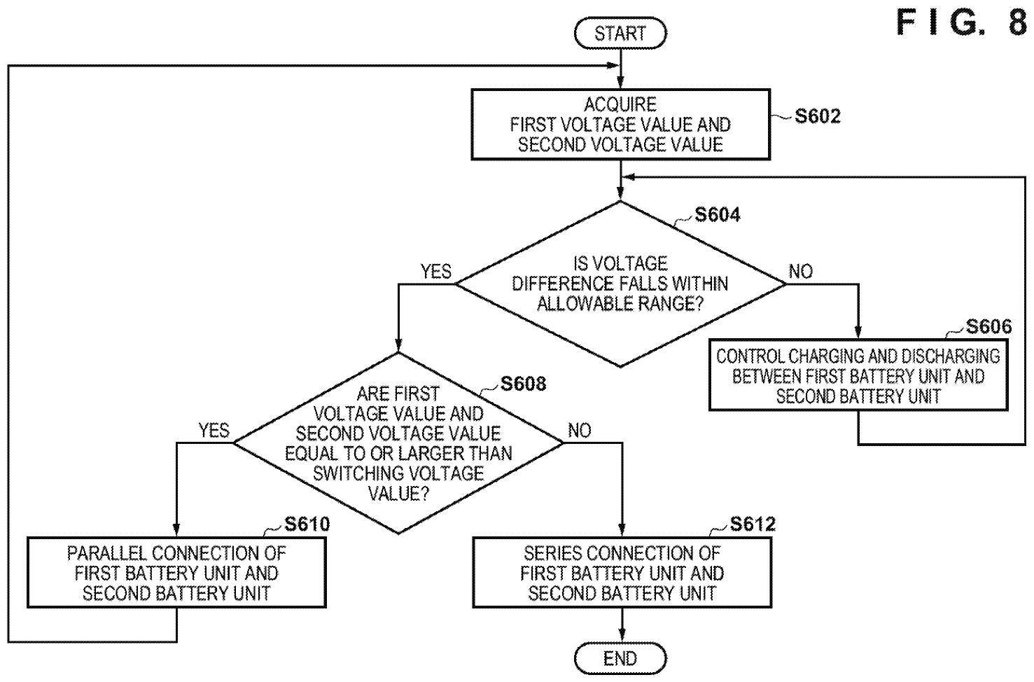

Hereinafter, an example of the operation of the power supply device 1 will be described with reference to FIG. 8. As described above, the power supply device 1 operates by the control unit 60 integrally controlling each unit of the power supply device 1. Here, the description will focus on control (control method) for switching the connection between the first battery unit 110 and the second battery unit 120 between the series connection and the parallel connection in particular.

In S602, the control unit 60 acquires the first voltage value that is the value of the voltage output from the first battery unit 110 and the second voltage value that is the value of the voltage output from the second battery unit 120. For example, the control unit 60 acquires, from the detection unit 50, the first voltage value detected by the first voltage detection unit 510 and the second voltage value detected by the second voltage detection unit 520.

In step S604, the control unit 60 determines whether or not a difference (voltage difference) between the first voltage value and the second voltage value acquired in S602 falls within an allowable range. When the difference between the first voltage value and the second voltage value does not fall within the allowable range, the process proceeds to S606. On the other hand, when the difference between the first voltage value and the second voltage value falls within the allowable range, the process proceeds to S608. Note that the allowable range of the difference between the first voltage value and the second voltage value is set in advance to an arbitrary voltage difference, for example, 1 V.

In S606, the control unit 60 controls charging and discharging between the first battery unit 110 and the second battery unit 120 so that the difference between the first voltage value and the second voltage value falls within the allowable range. For example, the control unit 60 compares the first voltage value and the second voltage value acquired in S602, and discharges only the battery unit having the higher voltage value in the first battery unit 110 and the second battery unit 120. As a result, electric power stored in the battery unit having the higher voltage value is supplied (charged) to the battery unit having the lower voltage value. As described above, by controlling charging and discharging between the first battery unit 110 and the second battery unit 120 so that the difference between the first voltage value and the second voltage value falls within the allowable range, overdischarging and overcharging in the first battery unit 110 and the second battery unit 120 can be suppressed (prevented).

In S608, the control unit 60 determines whether or not the first voltage value and the second voltage value acquired in S602 are equal to or larger than the switching voltage value for switching the connection between the first battery unit 110 and the second battery unit 120 from the parallel connection to the series connection. When the first voltage value and the second voltage value are equal to or larger than the switching voltage value, the process proceeds to S610. On the other hand, when the first voltage value and the second voltage value are equal to or larger than the switching voltage value, the process proceeds to S612.

When the process proceeds from S608 to S610, it is considered that there is a margin in the voltage value output from each battery BT included in each of the first battery unit 110 and the second battery unit 120. Therefore, in S610, the control unit 60 controls the switching unit 40 so that the connection between the first battery unit 110 and the second battery unit 120 is the parallel connection. As a result, electric power is supplied from the power supply unit 10 in which the first battery unit 110 and the second battery unit 120 are connected in parallel to the load LD via the DC/DC converter 20 and the DC/AC converter 30. Note that specific control for causing the connection between the first battery unit 110 and the second battery unit 120 to be the parallel connection is as described above, so that detailed description thereof will be omitted here. In a case where the switching unit 40 is controlled so that the connection between the first battery unit 110 and the second battery unit 120 is the parallel connection, the process proceeds to S602 in order to acquire the first voltage value output from the first battery unit 110 and the second voltage value output from the second battery unit

When the process proceeds from S608 to S612, it is considered that there is no margin in the voltage value output from each battery BT included in each of the first battery unit 110 and the second battery unit 120. Therefore, in S612, the control unit 60 controls the switching unit 40 so that the connection between the first battery unit 110 and the second battery unit 120 is the series connection. As a result, electric power is supplied from the power supply unit 10 in which the first battery unit 110 and the second battery unit 120 are connected in series to the load LD via the DC/DC converter 20 and the DC/AC converter 30. Note that specific control for causing the connection between the first battery unit 110 and the second battery unit 120 to be the series connection is as described above, so that detailed description thereof will be omitted here. In a case where the switching unit 40 is controlled so that the connection between the first battery unit 110 and the second battery unit 120 is the series connection, the operation is ended when the request for electric power from the load LD is stopped or the output of the electric power from the power supply unit 10 is impossible (for example, the voltage reaches the lower limit under the use conditions of each battery BT included in each of the first battery unit 110 and the second battery unit 120).

As described above, according to the present embodiment, in the power supply device 1 in which the plurality of batteries BT (the first battery unit 110 and the second battery unit 120) are mounted, the connection between the first battery unit 110 and the second battery unit 120 can be switched to the series connection or the parallel connection, so that new technology for reducing the overall size and cost of the power supply device 1 can be provided.

### Summary of Embodiments

1. A power supply device of the above embodiment is
a power supply device (for example, 1) for outputting a constant voltage to a load (for example, LD), characterized by comprising:
a power supply unit (for example, 10) that has a first battery unit (for example, 110) including at least one battery (for example, BT) and a second battery unit (for example, 120) including at least one battery;
a switching unit (for example, 40) that switches connection between the first battery unit and the second battery unit to series connection or parallel connection; and
a control unit (for example, 60), wherein
the control unit
controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and
controls the switching unit so that the connection between the first battery unit and the second battery unit is the series connection, when the first voltage value and the second voltage value are not equal to or larger than the switching voltage value.

According to this embodiment, it is possible to reduce the overall size and cost of the power supply device.

2. The power supply device (for example, 1) of the above embodiment,
characterized by further comprising:
a detection unit (for example, 50) that detects the first voltage value and the second voltage value, wherein
the control unit (for example, 60) determines whether or not the first voltage value and the second voltage value detected by the detection unit are equal to or larger than the switching voltage value.

According to this embodiment, since the value (first voltage value) of the voltage output from the first battery unit and the value (second voltage value) of the voltage output from the second battery unit can be always detected, the switching unit can be controlled with high accuracy.

3. The power supply device (for example, 1) of the above embodiment,
characterized by further comprising:
a converter (for example, 20) that is provided between the power supply unit (for example, 10) and the load (for example, LD) and boosts a DC voltage output from the power supply unit; and
an inverter that is provided between the converter and the load and converts the DC voltage boosted by the converter into an AC voltage.

According to this embodiment, since it is possible to reduce the size and cost of the converter, the overall size and cost of the power supply device can be reduced.

4. The power supply device (for example, 1) of the above embodiment,
characterized by further comprising: an inverter (for example, 30) that is provided between the power supply unit (for example, 10) and the load (for example, LD) and converts a DC voltage output from the power supply unit into an AC voltage.

According to this embodiment, since the number of batteries to be included in each of the first battery unit and the second battery unit can be reduced, the overall size and cost of the power supply device can be reduced.

5. The power supply device (for example, 1) of the above embodiment,
characterized in that
the switching unit (for example, 40) includes
a first relay (for example, 410) that switches a connection destination of a terminal (for example, 112) on a first electrode side of the first battery unit (for example, 110) to a terminal (for example, 122) on a first electrode side of the second battery unit (for example, 120) or a terminal (for example, 124) on a second electrode side of the second battery unit, and
a second relay unit (for example, 420) that switches a state between a terminal (for example, 114) on a second electrode side of the first battery unit and the terminal on the second electrode side of the second battery unit to a connected state or a non-connected state.

According to this embodiment, a function of switching the connection between the first battery unit and the second battery unit to the series connection or the parallel connection can be realized with a simple configuration.

6. The power supply device (for example, 1) of the above embodiment,
characterized in that
when the first voltage value and the second voltage value are equal to or larger than the switching voltage value, the control unit (for example, 60) controls the first relay (for example, 410) so that the terminal (for example, 112) on the first electrode side of the first battery unit (for example, 110) and the terminal (for example, 122) on the first electrode side of the second battery unit (for example, 122) are connected, and controls the second relay (for example, 420) so that the state between the terminal (for example, 114) on the second electrode side of the first battery unit and the terminal (for example, 124) on the second electrode side of the second battery unit is the connected state, and
when the first voltage value and the second voltage value are not equal to or larger than the switching voltage value, the control unit controls the first relay so that the terminal on the first electrode side of the first battery unit and the terminal on the second electrode side of the second battery unit are connected, and controls the second relay so that the state between the terminal on the second electrode side of the first battery unit and the terminal on the second electrode side of the second battery unit is the non-connected state.

According to this embodiment, the connection between the first battery unit and the second battery unit can be switched to the series connection or the parallel connection with a simple configuration.

7. The power supply device (for example, 1) of the above embodiment,
characterized in that the control unit (for example, 60) controls charging and discharging between the first battery unit (for example, 110) and the second battery unit (for example, 120) so that a difference between the first voltage value and the second voltage value falls within an allowable range.

According to this embodiment, it is possible to suppress (prevent) overdischarging and overcharging in the first battery unit and the second battery unit.

8. A control device of the above embodiment is
a control device (for example, 60) for controlling a power supply device (for example, 1) including a power supply unit (for example, 10) having a first battery unit (for example, 110) including at least one battery (for example, BT) and a second battery unit (for example, 120) including at least one battery, the power supply device outputting a constant voltage to a load (for example, LD), the control device characterized by comprising:
a switching unit (for example, 40) that switches connection between the first battery unit and the second battery unit to series connection or parallel connection; and
a control unit (for example, 60), wherein
the control unit
controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and
controls the switching unit so that the connection between the first battery unit and the second battery unit is the series connection, when the first voltage value and the second voltage value are not equal to or larger than the switching voltage value.

According to this embodiment, it is possible to reduce the overall size and cost of the power supply device.

9. A control method of the above embodiment is
a control method for controlling a power supply device (for example, 1) including a power supply unit (for example, 10) having a first battery unit (for example, 110) including at least one battery (for example, BT) and a second battery unit (for example, 120) including at least one battery, the power supply device outputting a constant voltage to a load (for example, LD), the method characterized by comprising:
a step of switching connection between the first battery unit and the second battery unit to series connection or parallel connection,
the step including
switching the connection between the first battery unit and the second battery unit to the parallel connection when a first voltage value that is a value of a voltage output from the first battery unit and a second voltage value that is a value of a voltage output from the second battery unit are equal to or larger than a predetermined switching voltage value, and
switching the connection between the first battery unit and the second battery unit to the series connection when the first voltage value and the second voltage value are not equal to or larger than the switching voltage value.

According to this embodiment, it is possible to reduce the overall size and cost of the power supply device.

The present invention is not limited to the above-described embodiments, and various changes and modifications can be made without departing from the spirit and scope of the present invention. Therefore, in order to make the scope of the present invention public, the following claims are attached.

### REFERENCE SIGNS LIST

1 Power supply device
10 Power supply unit
20 DC-DC converter
30 DC/AC inverter
40 Switching unit
50 Detection unit
60 Control unit
110 First battery unit
120 Second battery unit
410 First relay
420 Second relay
BT Battery
LD Load

1. A power supply device for outputting a constant voltage to a load, comprising:
a power supply unit that has a first battery unit including at least one battery and a second battery unit including at least one battery;
a switching unit configured to switch connection between the first battery unit and the second battery unit to series connection or parallel connection; and
a control unit configured to control the switching unit so that a voltage set value set in advance according to a specification required by the load is supplied to the load, wherein
the control unit
controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and
controls the switching unit so that the connection between the first battery unit and the second battery unit is the series connection, when the first voltage value and the second voltage value are not equal to or larger than the switching voltage value.

2. The power supply device according to claim 1, further comprising:
a detection unit configured to detect the first voltage value and the second voltage value, wherein
the control unit determines whether or not the first voltage value and the second voltage value detected by the detection unit are equal to or larger than the switching voltage value.

3. The power supply device according to claim 1, further comprising:
a converter that is provided between the power supply unit and the load and configured to boost a DC voltage output from the power supply unit; and
an inverter that is provided between the converter and the load and configured to convert the DC voltage boosted by the converter into an AC voltage.

4. The power supply device according to claim 1, further comprising: an inverter that is provided between the power supply unit and the load and configured to convert a DC voltage output from the power supply unit into an AC voltage.

5. The power supply device according to claim 1, wherein
the switching unit includes
a first relay configured to switch a connection destination of a terminal on a first electrode side of the first battery unit to a terminal on a first electrode side of the second battery unit or a terminal on a second electrode side of the second battery unit, and
a second relay unit configured to switch a state between a terminal on a second electrode side of the first battery unit and the terminal on the second electrode side of the second battery unit to a connected state or a non-connected state.

6. The power supply device according to claim 5, wherein
when the first voltage value and the second voltage value are equal to or larger than the switching voltage value, the control unit controls the first relay so that the terminal on the first electrode side of the first battery unit and the terminal on the first electrode side of the second battery unit are connected, and controls the second relay so that the state between the terminal on the second electrode side of the first battery unit and the terminal on the second electrode side of the second battery unit is the connected state, and
when the first voltage value and the second voltage value are not equal to or larger than the switching voltage value, the control unit controls the first relay so that the terminal on the first electrode side of the first battery unit and the terminal on the second electrode side of the second battery unit are connected, and controls the second relay so that the state between the terminal on the second electrode side of the first battery unit and the terminal on the second electrode side of the second battery unit is the non-connected state.

7. The power supply device according to claim 1, wherein the control unit controls charging and discharging between the first battery unit and the second battery unit so that a difference between the first voltage value and the second voltage value falls within an allowable range.

8. A control device for controlling a power supply device including a power supply unit having a first battery unit including at least one battery and a second battery unit including at least one battery, the power supply device outputting a constant voltage to a load, the control device comprising:
a switching unit configured to switch connection between the first battery unit and the second battery unit to series connection or parallel connection; and
a control unit configured to control the switching unit so that a voltage set value set in advance according to a specification required by the load is supplied to the load, wherein
the control unit
controls the switching unit so that the connection between the first battery unit and the second battery unit is the parallel connection, when a first voltage value that is a value of a voltage output from the first battery unit and a second voltage value that is a value of a voltage output from the second battery unit are equal to or larger than a predetermined switching voltage value, and
controls the switching unit so that the connection between the first battery unit and the second battery unit is the series connection, when the first voltage value and the second voltage value are not equal to or larger than the switching voltage value.

9. A control method for controlling a power supply device including a power supply unit having a first battery unit including at least one battery and a second battery unit including at least one battery, the power supply device outputting a constant voltage to a load, the method comprising:
a step of switching connection between the first battery unit and the second battery unit to series connection or parallel connection so that a voltage set value set in advance according to a specification required by the load is supplied to the load,
the step including
switching the connection between the first battery unit and the second battery unit to the parallel connection when a first voltage value that is a value of a voltage output from the first battery unit and a second voltage value that is a value of a voltage output from the second battery unit are equal to or larger than a predetermined switching voltage value, and
switching the connection between the first battery unit and the second battery unit to the series connection when the first voltage value and the second voltage value are not equal to or larger than the switching voltage value.
